(19) United States
(12) Patent Application Publication
(10) Pub. No.: US 2004/0056077 A1
(43) Pub. Date: Mar. 25, 2004

(54) Sheet welding machine

(76) Inventor: Kanji Ito, Saitama (JP)

Correspondence Address: David E Dougherty, Dennison Schultz & Dougherty, 612 Crystal Square 4, 1745 Jefferson Davis Highway, Arlington, VA, 22202, US

(21) Appl. No.: 10/466,542

(22) PCT Filed: Jan. 29, 2001
(86) PCT No.: PCT/JP01/00572

(51) Int. Cl. B23K 31/02

(52) U.S. Cl. 228/235.2; 228/5.7

(57) ABSTRACT

A sheet welding machine according to the present invention comprises a wedge-shaped heater adapted to be in heat-transferable contact with edge portions of upper and lower sheets for melting the edge portions with heat, and a pair of upper and lower pressure rollers disposed in proximity to a converging portion of the heater, wherein the edge portions of the two sheets are continuously welded by the heater and the pressure rollers. The sheet welding machine has a compressed air delivery tube connected to a compressed air source, the delivery tube projecting from the converging portion at a middle part of the heater in a direction of travel of the sheets. A frontward end portion of the delivery tube extends through a nip between the pressure rollers and discharges the compressed air forwardly in the direction of travel of the sheets. The edge portions of the sheets overlapping each other are formed with continuous welded zones in two rows and the edge portions are welded together. At the same time, a channel filled with the compressed air is formed between the right and left welded zones. According to this welding machine, since welding operation can be carried out while detecting air leakage from the channel during welding operation, it is possible to locate a defective weld spot and repair it, immediately after the defective weld appears.

### TECHNICAL FIELD

The present invention relates to a sheet-welding machine, and more specifically, to such a machine for continuously welding edge portions of two sheets with use of a wedge-shaped heater and pressure rollers.

### TECHNICAL BACKGROUND

Heat weldable thermoplastic resin sheets, such as polyvinyl chloride resin sheets, are practically in use for building construction works or civil engineering works, in which the sheets are used as waterproofing sheets or membrane materials, such as waterproofing sheets for ground improvement, waterproofing sheets for water sealing, drainage or shielding of structures in tunnel constructions or like, and membrane materials for dome or tent structures. In general, where the waterproofing sheets are to be provided in a wide area, a plurality of waterproofing sheets are overlapped at their edge portions and the edge portions are thermally welded to each other such that a continuous waterproofing sheet is formed over a wide area.

A type of heat welding machines for welding sheets is known in the art, which is disclosed in, for instance, Japanese patent laid-open publication No. 10-128850 (Japanese patent application No. 8-289666) and Japanese patent laid-open publication No. 7-314558 (Japanese patent application No. 6-133717). Such a sheet welding machine is provided with upper and lower pressure rollers in a pair and a heater for heating edge portions of sheets. The edge portions of sheets melted with heat are pressed between the pressure rollers, so that the edge portions are integrally jointed. A drawback of this type of sheet welding machine is that occurrence of an incomplete or defective weld in a welded zone cannot be readily inspected because the machine allows the edge portions of the two sheets to be jointed merely by means of a welded zone in a single row.

As another type of sheet welding machines, a double-row type of welding machine is known in the art, which is arranged to joint the edge portions of sheets with parallel welded zones in two rows. The double-row type of sheet welding machine forms a continuous unwelded section between the right and left welded zones and the unwelded section constitutes a continuous channel into which a quantity of air can be charged in a sealed condition. An inspection for detecting incomplete weld of the welded zones is carried out by charging compressed air into the channel after the welding operation has been finished. If an incomplete or defective weld exists in the welded zones, the compressed air leaks therefrom and therefore, the incompletely welded spot can be repaired or re-welded.

FIGS. 5A, 5B and 6A are a perspective view and cross-sectional views illustrating the double-row type of sheet welding machine, and FIG. 6B is a plan view showing a way of inspecting welded sheets.

As shown in FIGS. 5A and 5B, a welding mechanism 50 of the sheet welding machine is provided with a wedge-shaped heater 55 having an electric heating wire (not shown) therein, and upper and lower pressure rollers 51R, 52R: 51L, 52L located in close proximity to a tip portion of the heater 55. The right and left rollers 51R, 51L: 52R, 52L are connected to each other by means of small-diameter shafts 53. A tongue-like plate 54 extends frontwardly from a converging portion 59 of the heater 55 and projects forwardly from the area between the upper and lower shafts 53.

The pressure rollers 51:52 are rotated by a driving torque of an electric motor 56, in directions indicated by arrows. Edge portions A1:A2 of upper and lower sheets W1:W2 are in contact with upper and lower surfaces of the heater 55 at a high temperature so that the edges are melted with heat. The melted edge portions are pressed between the upper and lower pressure rollers 51:52 so as to be compressively bonded together. As illustrated in FIG. 5B, the tongue-like plate 54 separates the sheets W1:W2 at a center part of the welding mechanism 50, so that an unwelded section C is formed between the right and left welded zones B1:B2. The section C provides a continuous channel sealingly chargeable with a quantity of compressed air for inspection.

An inspection is carried out after finishing the welding operation, in which an end portion E of the channel C is air-tightly sealed as shown in FIG. 6B, and the channel C is penetrated with a needle 60 for inspection, the needle 60 being provided with a compressed air passage 61. An air discharge port 62 of the passage 61 discharges the compressed air CA into the channel C, so that the channel C is filled with the compressed air. If a defective weld exists in the welded zone B, the compressed air leaks to the ambient atmosphere, and therefore, existence or absence of the incomplete weld can be detected.

However, such a method of inspection has to be carried out after all of the welding steps have been finished, and the spot of defective weld is difficult to be located, even if existence of defective weld can be detected. Therefore, a re-inspection has to be carried out for locating the spot of defective weld, or re-welding works have to be performed over an extensive area of the joint zone which includes a welded part doubtful as being a defective weld spot.

Further, according to the arrangement of the welding mechanism as set forth above, a joint width X in the edge portions of the sheets is relatively widely required, which exceeds the overall width of the welding mechanism including the pressure rollers in two rows and the shaft therebetween. Therefore, as the overlap width X of the sheets is so wide, useless materials of the sheets are increased.

In addition, the aforementioned arrangement of the welding mechanism includes the pressure rollers in two rows spaced apart a distance. In a case where the welded zone is to be changed in its direction or to be curved in correspondence with the profile or configuration of the sheets, differential motion is caused between rotation of the right roller and that of the left roller when the welding machine changes its orientation, and therefore, changes in orientation of the welding machine may be obstructed.

It is an object of the present invention to provide a sheet welding machine which is capable of performing an inspection of a defective weld simultaneously with the welding operation.

It is another object of the present invention to provide a sheet welding machine which enables reduction in a joint width of the sheets for efficient use of materials of the sheets.

It is still another object of the present invention to provide a sheet welding machine which can smoothly change its orientation in conformity to curves of the welded zone or changes in direction thereof.

### DISCLOSURE OF THE INVENTION

The present invention provides a sheet welding machine continuously welding edges of two sheets with use of a wedge-shaped heater and pressure rollers, and forming a channel between welded zones in two rows, the channel being chargeable with fluid for inspection of a defective weld in the welded zone, comprising:

the wedge-shaped heater (15) adapted to be in heat-transferable contact with the edge portions (A1:A2) of the upper and lower sheets (W1:W2) so as to melt the edge portions with heat; the upper and lower pressure rollers (11,12) in a pair located in proximity to a convergent part (19) of said heater; and a compressed air delivery tube (20) projecting from said convergent part at a middle part of said heater in a direction of travel of said sheets, a frontward end portion (25) of said tube extending into a nip (N) of said rollers and extending therethrough, and the frontward end portion discharging compressed air (CA) forwardly in the direction of travel of said sheets.

According to the present invention, the edge portions of the sheets are pressed and compressively bonded together by the pressure rollers immediately after the edge portions are melted by the heater. The compressed air delivery tube separates the upper and lower sheets in contact therewith and forms a continuous unwelded zone by means of the compressed air discharged from the frontward end portion of the tube. The unwelded zone constitutes the continuous channel (C) which divides the welded zone made by the rollers, into right and left welded zones (B1:B2), and the channel is air-tightly filled with the compressed air. If a defective weld appears during operation of bonding the sheets with use of the sheet welding machine, the compressed air in the channel is released to the ambient atmosphere so that the channel loses its air cushioning property, and therefore, the occurrence of defective weld can be immediately detected.

Further, since the welded zones in two rows can be formed by the pressure rollers arranged in a single row, the width of overlapping edge portions of the sheets (joint width X) can be decreased or reduced to be a dimension slightly exceeding the width of a single pressure roller. Furthermore, the sheet welding machine with the pressure rollers arranged in a single row can overcome difficulties of changes in orientation resulting from the difference in rotation between the right and left rollers, and therefore, the sheet welding machine can smoothly change its orientation in conformity with curves of the welded zone or changes in the direction thereof.

In a preferred embodiment of the present invention, a metallic roller in a cylindrical form is used as the pressure roller. Alternatively, the pressure roller may be a cylindrical roller made of heat-resistant resin, rubber or elastomer. If desired, the pressure roller is formed with a circumferential groove (40) in an area of the roller in conformity with the compressed air delivery tube. The circumferential groove locally relieves the compressive force acting on the area of the sheets into which the delivery tube is inserted, so that formation of the channel is facilitated with partial elastic deformation of the sheets.

Preferably, the delivery tube is a metallic tube having a round cross-section and a frontward end face of the tube constitutes a round opening. The frontward end portion of the delivery tube may be flattened and expanded transversely, so that the frontward end face of the delivery tube constitutes an ellipse or oval opening.

From another aspect of the present invention, a method of welding sheets is provided, in which edge portions of two sheets are continuously welded with use of a wedge-shaped heater and pressure rollers so that welded zones are formed in two rows and that a channel chargeable with fluid is formed between the welded zones, and an inspection of defective weld in the welded zone is carried out by charging compressed air in the channel, comprising steps of:

melting the edge portions of the sheets with heat by said heater and pressing said edge portions by said rollers while discharging compressed air from a compressed air delivery tube disposed in a center area of said heater; and

welding the overlapping edge portions of the sheets by forming continuous melted zones in two rows in the edge portions, and simultaneously forming a channel charged with the compressed air between said melted zones, so that the inspection of defective weld is carried out by detecting leakage of air from said channel, during welding operation.

### BRIEF DESCRIPTION OF THE DRAWINGS

FIG. 1A is a perspective view generally showing a preferred embodiment of a sheet welding machine according to the present invention, and FIG. 1B is a perspective view showing a welding mechanism of the sheet welding machine;

FIG. 2A is a front elevational view showing the welding mechanism and FIG. 2B is a plan view of the welding machine;

FIG. 3A is a cross-sectional view taken along line I-I as shown in FIG. 2A, and FIG. 3B is a cross-sectional view taken along line II-II as shown in FIG. 2A;

FIG. 4A is a perspective view illustrating a structure of forwardmost end portion of an air delivery tube, FIG. 4B is a perspective view illustrating an alternative structure of the forwardmost end portion of the air delivery tube, and FIG. 4C is a perspective view illustrating an alternative structure of the heating rollers in the welding mechanism;

FIGS. 5A and 5B are a perspective view and a front elevational view showing a conventional welding mechanism; and

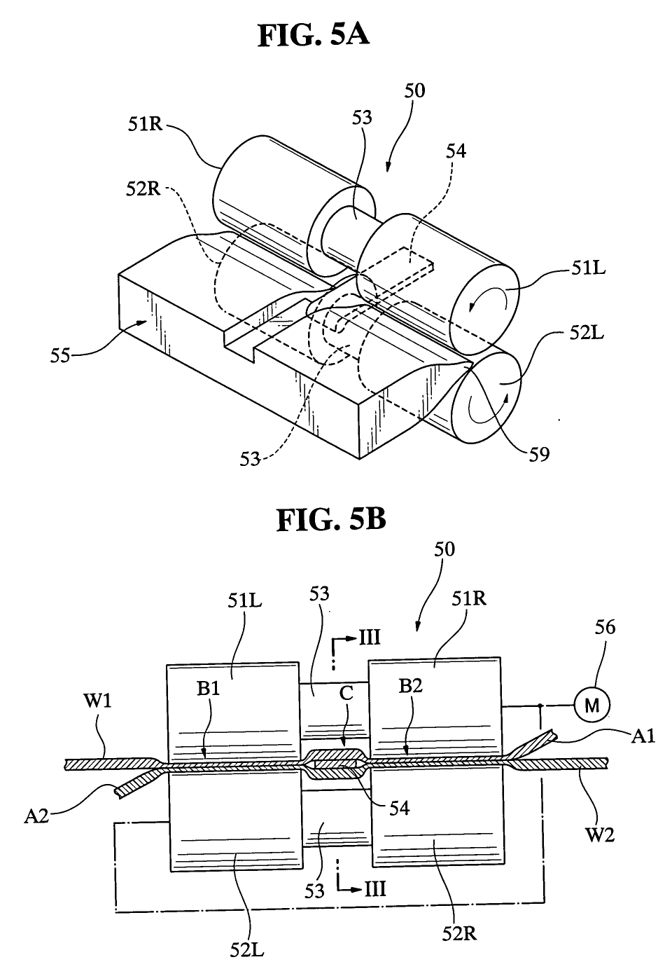

FIG. 6A is a cross-sectional view taken along line III-III as shown in FIG. 5B, and FIG. 6B is a plan view illustrating a method of inspecting sheets welded with use of the conventional welding mechanism.

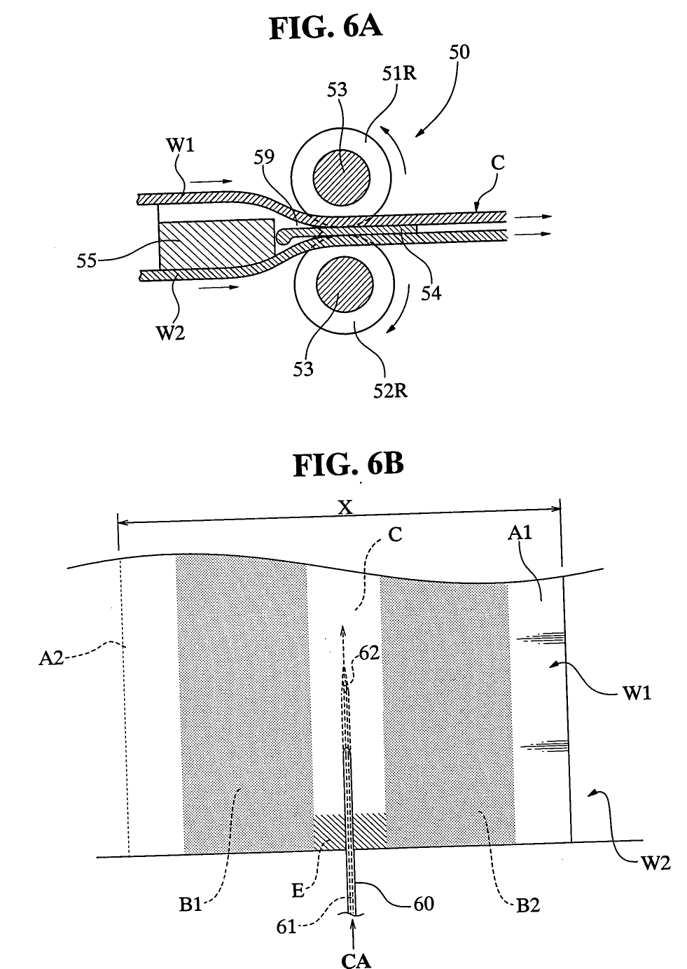

### BEST MODE FOR CARRYING OUT THE INVENTION

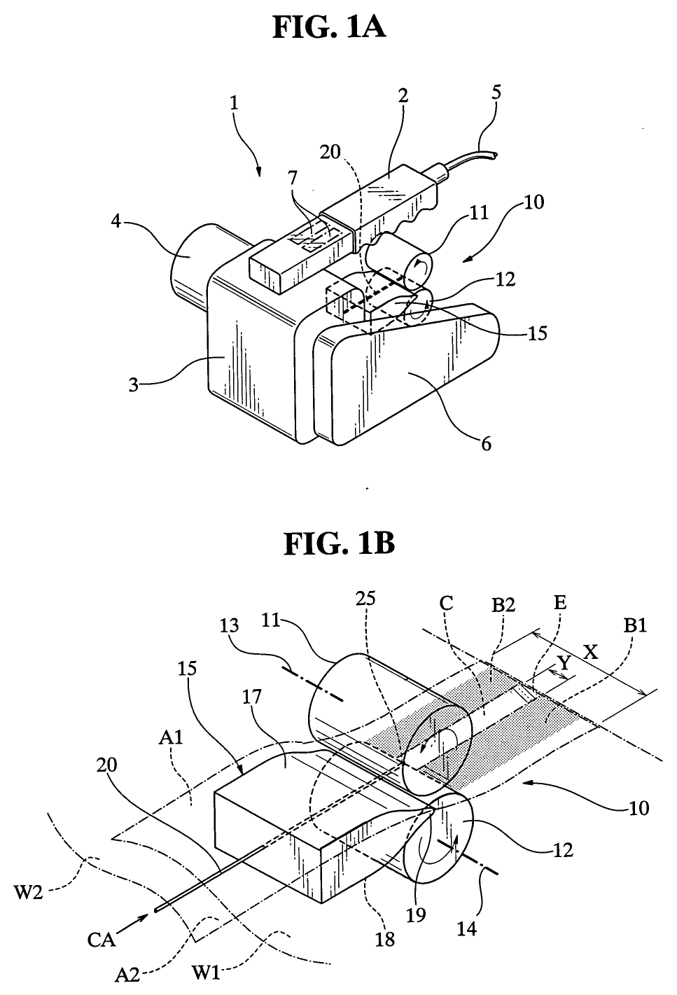

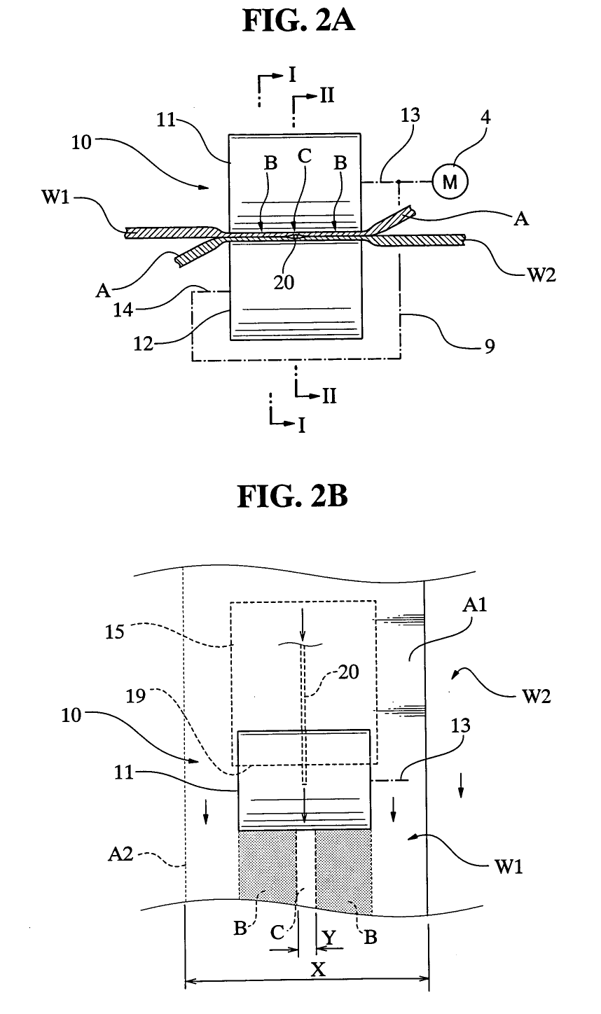

A preferable embodiment of the sheet welding machine according to the present invention is illustrated in FIGS. 1 through 3.

The sheet welding machine 1 is provided with a grip handle 2 which can be held with a hand, a body 3 integrally connected to the handle 2, and an electric motor 4 mounted on the body 3. An electric power cable 5 is coupled to a distal end of the handle 2. Side covers 6 for the body 3 are attached to sides of the body 3, and a welding mechanism 10 is equipped inside of the side cover 6. The welding mechanism includes upper and lower pressure rollers 11,12 in a pair, a wedge-shaped heater 15 and a compressed air delivery tube or pipe 20.

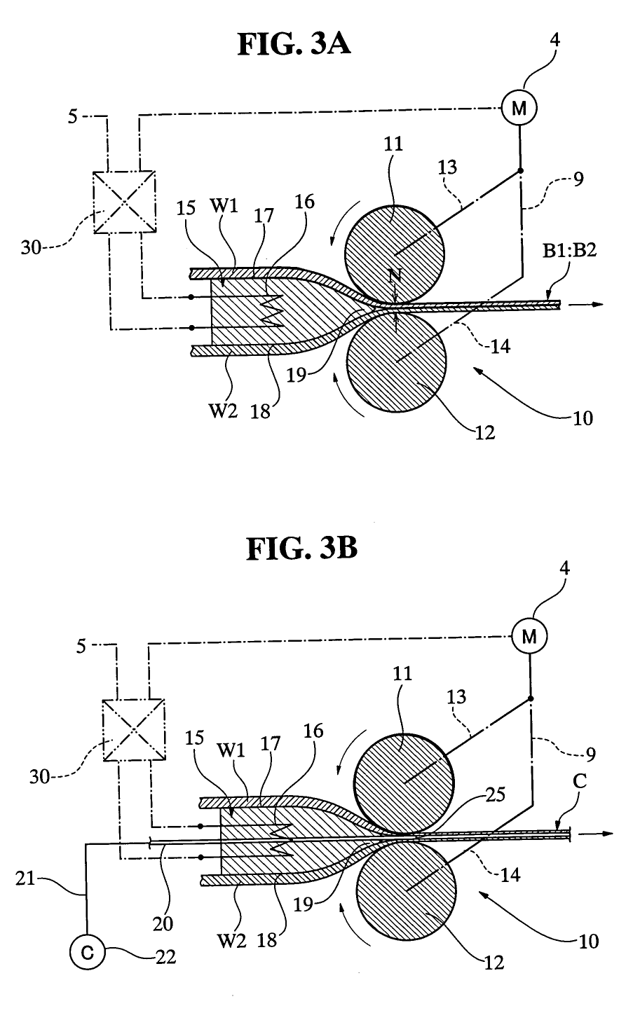

The cable 5 is connected to a battery, an external electric power source or an electric power transformer, and the body 5 is equipped with an electric circuit 30 (FIG. 3) therein, to which electric power is supplied. The electric circuit 30 includes a manually operative switches 7 for manually operating the electric motor 4 and the heater 15, a speed control means for controlling the rate of rotation in the motor 4 or a variable speed mechanism of the motor 4, temperature control means for controlling a surface temperature of the heater 15, and an air discharge control means for controlling an air discharge rate of the compressed air delivery tube 20. The circuit 30 is arranged to control the operation of the motor 4 and the heater 15.

A driving power transmission mechanism 9 is provided inside of the side cover 6, and the mechanism 9 transmits the rotation of the motor 4 to center shafts 13, 14 of the pressure rollers 11,12. The mechanism 9 allows the driving torque of the motor 4 to be transformed to rotation of the rollers 11, 12 in directions indicated by arrows.

The heater 15 constituting the welding mechanism 10 is formed in a configuration of wedge converging in a nip of the rollers 11,12, as shown in FIG. 3. The compressed air delivery tube 20 extends through the heater 15 at a middle part of its width and forwardly projects from a converging part 19. The heater 15 has an electric heating wire 16 therein and the wire 16 is connected to the electric circuit 30. An upper surface 17 and a lower surface 18 of the heater 15 are heated by electrically charging the heating wire 16.

The pressure rollers 11,12 are located in close proximity to the converging part 19, and positioned in a vertically symmetric layout with respect to a center plane of the heater 15. The rollers 11,12 are knurled on its external surfaces. The converging part 19 extends into the nip of the rollers 11,12 and converges therein. The dimension N of the nip of the rollers 11,12 is predetermined so that the sheets W1:W2 are pressed to a suitable thickness. The backward end portion of the tube 20 is connected to a compressor 22 through a compressed air supply tube 21, whereas the frontward end portion 25 of the tube 20 extends through the nip of the rollers 11,12 and terminates at an area slightly forward of the nip. The compressor 22 defining the compressed air source may be built-in in a part of the body 3; or otherwise, it may be located outside of the machine and connected to a control valve in the body 3 by means of a compressed air feed pipe or tube.

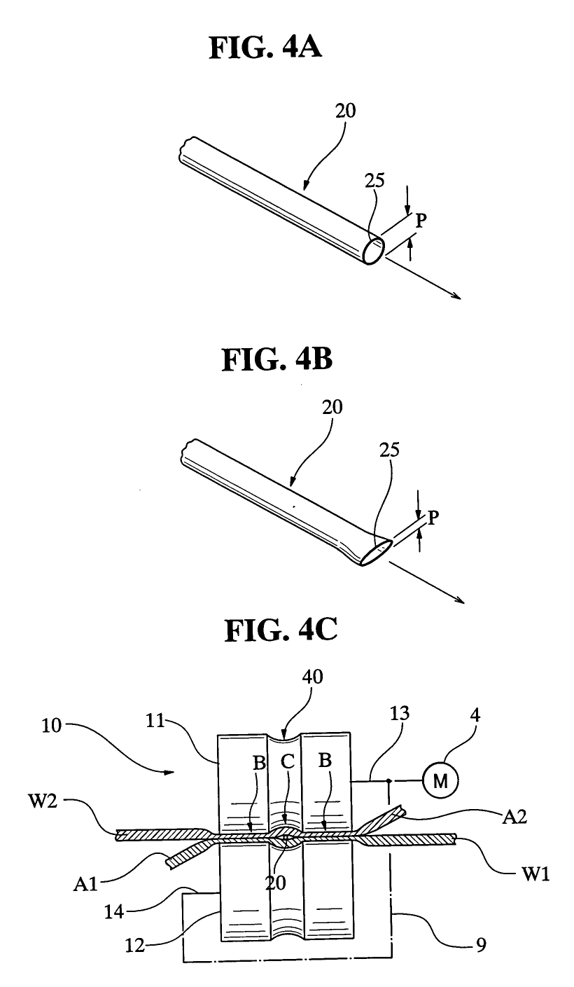

A configuration of the frontward end portion 25 of the compressed air delivery tube 20 is illustrated in FIG. 4A. The end portion 25 is formed to be round in its cross-section such that the tube 20 is vertically cut, and the compressed air of the tube 20 is discharged therefrom forwardly. As shown in FIG. 4B, the end portion 25 may be flattened so as to be configured in an ellipse or oval cross-section transversely elongated, so that the height P of the end portion 25 is reduced.

The tube 20 is set to have a predetermined diameter ranging from 0.5 mm to 3.0 mm, e.g., 2.0 mm, and the pressure of the compressed air is set to be in a range from 1.5 to 3.0 kg/cm²(G), e.g., 2.0 kg/cm²(G). In general, the sheet W1:W2 has a thickness in a range from 1.0 mm to 5.0 mm, and usually, sheets W1:W2 having an order of 2.0 mm˜3.0 mm in thickness are used in many construction sites. The dimension N of the nip of the roller 11,12 is set to be approximately an order of 1.5 mm˜7.0 mm, preferably, an order of 3.0˜5.0 mm. The width of the roller 11,12 is set to be approximately in a range from 10 mm to 40 mm, preferably, the rollers 11,12 are set to be 15 mm or less in width. If desired, the width of the roller 11,12 can be set to be approximately 10 mm.

A metallic cylindrical form or a cylindrical form made of heat resistant resin, rubber or elastomer may be used as the pressure roller 11,12. In use of the roller made of heat resistant resin, rubber or elastomer, an expansion around the tube 20 can be advantageously compensated for to some extent by elastic deformation of the surface of roller. The resin, rubber or elastomer, which has a heat-resisting property resistant against a temperature above 300° C., preferably, above 500° C., is employed as the material for forming the roller 11,12.

The operation of the sheet welding machine 1 is described hereinafter.

The sheet welding machine 1 is applied to a joint part of two sheets A1, A2. The upper sheet A1 is inserted into the nip N of the rollers 11,12 along the upper surface of the heater 15, whereas the lower sheet A2 is inserted into the nip N thereof along the lower surface of the heater 15. The switches 7 on the handle 2 are changed over to a heating position, whereby the heating wire 16 of the heater 15 can be energized so as to heat the upper and lower surfaces of the heater 15 up to a melting temperature of the sheets W1:W2. The switches 7 are further changed over to a position for driving the motor, so that the motor 4 is driven in rotation. The rollers 11,12 are rotated in the directions of the arrows, so that the sheets W1:W2 are drawn into the nip N and pressed between the rollers 11,12. The opposite surfaces of the sheets W1:W2 are thermally melted and pressed to each other under pressure of the rollers 11,12 to join together. The -sheet welding machine 1 is moved in a constant velocity along the edge portions A1:A2 of the sheets W1:W2, whereby the overlapping edge portions A1:A2 of the sheets W1:W2 can be continuously welded together.

During such a welding operation, the compressed air delivery tube 20 successively discharges a quantity of compressed air. The thermally melted sheets W1:W2 are locally cooled down by the compressed air discharged from the frontward end portion 25 of the tube 20, and the flow of compressed air locally prevents the melted sheets W1:W2 from bonding together. As the result, a channel C having a predetermined width Y is formed, which is centered at the axis of the tube 20, and welding zones B1:B2 in two rows are formed on both sides of the channel C.

According to the sheet welding machine 1 as set forth above, the welding operation is performed in a condition that the frontward end portion E of the channel C is air-tightly sealed, whereby a defective weld caused during the welding operation, if any, can be found or located immediately. In other words, since the pressure of air in the channel is rapidly reduced if a defective weld spot happens, a part of the sheets W1:W2 on the channel C immediately loses its air cushioning or repulsive action, and therefore, the operator may interrupt the welding work and quickly repair the defective weld spot.

Further, in the aforementioned arrangement of the sheet welding machine 1, it is sufficient to ensure a joint width X (overlapping width) of the sheets W1:W2 slightly greater than the width of the single roller 11,12, and therefore, the joint width of the sheets W1: W2 can be reduced and materials of the sheets can be effectively used.

In addition, the sheet welding machine 1 with the aforementioned arrangement is adapted to perform the welding operation with use of the upper and lower rollers 11,12 in a single row, and therefore, the sheet welding machine 1 can smoothly change its orientation where the joint part is curved or changed in its direction. Thus, it is possible to relatively easily perform a continuous welding operation in accordance with the curves of the joint part or changes in the direction thereof.

FIG. 4C is a front elevational view showing an alternative embodiment of the welding mechanism 10.

The pressure roller 11,12 in this embodiment is partially reduced in its diameter at a widthwise middle part, so that an arc-shaped groove 40 circumferentially extending around the roller 11,12 is formed in a position in correspondence with the compressed air delivery tube 20. The upper and lower circumferential grooves 40 allow the sheets W1:W2 to be elastically deformed so that the channel C can be easily formed by means of the tube 20. The circumferential groove 40 may be formed to have a cross-section of a (rectangular) recess.

Although the present invention has been described as to specific embodiments, the present invention is not limited to such embodiments, but may be modified or changed without departing from the scope of the invention as defined in the attached claims.

For instance, the compressed air delivery tube is not limited to be positioned on the center line of the heater, but may be located in a position transversely deviated from the center of the heater to some extent.

Further, the design of structure for supporting the compressed air delivery tube can be appropriately modified in such a manner that the dimension of the part of the tube projecting from the converging part, or the position of the frontward end portion of the tube can be variably controlled or adjusted. For example, the structures of the heater and the tube may be modified such that the tube is supported by the heater so as to be displaceable with respect to the heater.

Industrial Applicability

According to the present invention, a sheet welding machine can be provided, which is capable of performing an inspection of a defective weld during the welding operation. The sheet welding machine in accordance with the present invention enables reduction in the joint width of the sheets for efficient use of the sheets and smooth changes in its orientation in conformity with the curves of the welded zone or changes in the direction thereof.

1. A sheet welding machine continuously welding edges of two sheets with use of a wedge-shaped heater and pressure rollers, and forming a channel between welded zones in two rows, the channel being chargeable with fluid for inspection of a defective weld in the welded zone, comprising:
the wedge-shaped heater adapted to be in heat-transferable contact with the edge portions of the upper and lower sheets so as to melt the edge portions with heat; the upper and lower pressure rollers in a pair located in proximity to a convergent part of said heater; and a compressed air delivery tube projecting from said convergent part at a middle part of said heater in a direction of travel of said sheets, a frontward end portion of said tube extending into a nip of said rollers and extending therethrough, and the frontward end portion discharging compressed air forwardly in the direction of travel of said sheets.

2. A sheet welding machine as defined in claim 1, wherein said pressure roller is a metallic cylindrical form with its surface being knurled.

3. A sheet welding machine as defined in claim 1, wherein said pressure roller is a cylindrical form made of heat-resistant resin, rubber or elastomer.

4. A sheet welding machine as defined in one of claims 1 to 3, wherein said pressure roller is formed with a circumferential groove extending around the roller at a middle area of the roller in correspondence with said delivery tube.

5. A sheet welding machine as defined in one of claims 1 to 4, wherein said delivery tube is a metallic tube having a round cross-section and a frontward end face of the tube forms a round opening.

6. A sheet welding machine as defined in one of claims 1 to 4, wherein said frontward end portion of said delivery tube is flattened and is expanded widthwisely, and a frontward end face of the tube forms an ellipse or oval opening.

7. A method of welding sheets in which edge portions of two sheets are continuously welded with use of a wedge-shaped heater and pressure rollers so that welded zones are formed in two rows and that a channel chargeable with fluid is formed between the welded zones, and an inspection of defective weld in the welded zone is carried out by charging compressed air in the channel, comprising steps of:
melting the edge portions of the sheets with heat by said heater and pressing said edge portions by said rollers while discharging compressed air from a compressed air delivery tube disposed in a center area of said heater; and
welding the overlapping edge portions of the sheets by forming continuous melted zones in two rows in the edge portions, and simultaneously forming a channel charged with the compressed air between said melted zones, so that the inspection of defective weld is carried out by detecting leakage of the air from said edge portions, during welding operation.

8. A method of welding sheets as defined in claim 7, wherein sheet welding operation is interrupted for repairing the defective weld when the defective weld is detected in the welded zone, and after repairing the defective weld, the welding operation is to be continued.

9. A method of welding sheets as defined in claim 7 or 8, wherein said pressure roller is set to be equal to or less than 15 mm in width, and overall width (X) of the welded zones in two rows is set to be equal to or less than 15 mm.
